(19) United States
(12) Patent Application Publication
(10) Pub. No.: US 2011/0123907 A1
(43) Pub. Date: May 26, 2011

(54) ELECTRODE, AN ELECTROCHEMICAL DEVICE AND METHOD THEREOF

(76) Inventor: Siu-Tung Yau, Solon, OH (US)

(21) Appl. No.: 13/054,952

(22) PCT Filed: Jul. 23, 2009
(86) PCT No.: PCT/US09/51567

§ 371 Date: Jan. 20, 2011

Related U.S. Application Data
(60) Provisional application No. 61/082,984, filed on Jul. 23, 2008.

(51) Int. Cl. H01M 4/86; H01M 4/02; H01M 4/62

(52) U.S. Cl. 429/523; 429/209; 429/212; 429/232

(57) ABSTRACT

The invention provides an electrode and an electrochemical device including the electrode. The electrode comprises a spatial confining structure such as grooves and an active compound such as glucose oxidase (GOx). The grooves spatially confines GOx, and stabilizes its enzymatic activity. Also provided is a method of stabilizing the activity of an active compound such as GOx. The invention can be widely used in development of an energy-generation device such as a fuel cell, a memory, an electrochemical reactor, a supercapacitor, a biosensor and a medical device thereof such as artificial pancreas, and a sensor such as detector of redox reactant.

This application claims the priority based on the U.S. Provisional Application 61/082,984 filed on Jul. 23, 2008, which is incorporated herein by reference in its entirety.

### BACKGROUND OF THE INVENTION

The present invention is related to an electrode coupled with an active compound such as glucose oxidase (GOx), an electrochemical device thereof, and a method thereof. It finds particular application in conjunction with a bioelectronic device, for example, a fuel cell such as a biofuel cell, and a sensor such as a biosensor; and will be described with particular reference thereto. However, it is to be appreciated that the present exemplary embodiments are also amenable to other like applications.

Currently, bioelectronic devices suffer from performance degradation due to the instability of enzymes, which are used as either the sensing element or the energy converting element. Moreover, biosensors have undesirably short life-time due to the inherent instability of the enzymes that lead to denaturation under non-native conditions. In commercial glucose biosensors, GOx is immobilized in a gel, which serves the purpose of hosting the enzyme on the sensing electrode. However, the gel is not a stable medium for long-term applications. Also, the gel may produce a barrier for glucose to reach the enzyme, making mass transport difficult.

A thrust in the present bioelectronic research is to obtain enhanced electron transfer at the interface between immobilized proteins/enzymes and the electrode of amperometric devices such as biofuel cells and biosensors. Sensors with high sensitivity and biofuel cells with high current density can be realized with high interfacial electron transfer. However, in general, when enzymes are immobilized on inorganic solid surfaces, interfacial interactions and an altered environment may induce changes in the native conformation of enzymes. Drastic changes may produce detrimental effects on enzymes so that they lose their enzymatic activity. The problem of enzyme denaturation is, in general, solved by introducing an intervening layer of organic materials between the electrode and proteins/enzymes. However, the thickness of the intervening layer causes additional impedance for electron transfer. Denaturation can also be caused by the heat generated at the enzyme-electrode interface of biofuel cells. Thus, techniques need to be developed for preparing an enzyme-electrode interface, which provides enhanced electron transfer with increased enzyme stability.

As disclosed in Lei, C.; Shin, Y.; Liu, J.; Ackerman, E. J. J. Am. Chem. Soc. 2002, 124, 11242; and Kumar, C. V.; Chaudhari, A. J. Am. Chem. Soc. 2000, 122, 830, when proteins are encapsulated in porous materials or entrapped inside layered materials, they are protected against denaturation with retained bioactivity.

Recently, Zhou et al. have proposed a theoretical treatment of spatial confinement of proteins based on the estimation of the change of the folding free energy of a protein as a function of spatial confinement, in Zhou, H.-X.; Dill, K. A. Biochemistry 2001, 40, 11289; and Zhou, H.-X. Acc. Chem. Res. 2004, 37, 123. For a protein confined in a cubic cage, the free energy difference exhibits a minimum when the size of the cage is just slightly larger than the size of the native protein. This is the condition for the confined protein to acquire maximum stability. Even when the cage size is 6 times that of the native protein, the stabilization due to spatial confinement is still on the order of k_{B}T. However, the high degree of confinement may have implications on the reaction kinetics. For bioelectronic applications, the requirement of sensitivity and current density makes these immobilization techniques unsuitable.

Advantageously, the present invention provides a combination of a spatial confining structure in an electrode and an active compound such as enzyme, wherein the spatial confining structure spatially confines the active compound, and stabilizes the activity of the compound, among others.

### BRIEF DESCRIPTION OF THE INVENTION

One aspect of the invention is to provide an electrode comprising a spatial confining structure and an active compound, wherein the spatial confining structure spatially confines the active compound, and stabilizes the activity of the compound.

Another aspect of the invention is to provide an electrochemical device including an electrode comprising a spatial confining structure and an active compound, wherein the spatial confining structure spatially confines the active compound, and stabilizes the activity of the compound.

Still another aspect of the invention is to provide a method of stabilizing the activity of an active compound, which comprises using an electrode comprising a spatial confining structure, wherein the spatial confining structure spatially confines the active compound.

### BRIEF DESCRIPTION OF THE DRAWINGS

FIG. 1 shows the AFM image (3 μm×3 μm) of a scratched silicon wafer surface with parallel grooves in an embodiment of the invention;

FIG. 2 shows a line profile of a region on the surface of a scratched silicon wafer, indicating grooves with a typical cross-sectional size of 25 nm×6 nm (width×depth);

FIG. 3 shows the comparison of cyclic voltammograms (CVs) between a scratched silicon wafer and a flat silicon wafer in PBS at pH 7.0;

FIG. 4 shows the AFM image (2 μm×2 μm) of a scratched silicon wafer surface with grooves immobilized with individual GOx molecules, and aggregation of two to three GOx molecules;

FIG. 5 shows the CV of the GOx-groove sample as shown FIG. 4 before subjecting it to guanidinium chloride (GdmCl) treatment;

FIG. 6 shows the CV (curve a) of a GOx-groove sample after a 4 hours of GdmCl treatment, and the CV (curve b) of a GOx immobilized flat silicon sample;

FIG. 7 shows the CV (curve a) of a GOx-groove sample and the CV (curve b) of a GOx-immobilized flat silicon sample, both samples having been treated with heat;

FIG. 8A shows the CV of a GdmCl-treated GOx-groove sample in the positive potential range, where in curve “a” was obtained in PBS only, and curve “b” was obtained with 4 mM glucose added to the PBS; and the inset is the calibration of the sample obtained at 0.7 V.

FIG. 8B shows the CV of the GOx-groove sample exposed to 80° C. in the positive potential range, wherein curve “a” was obtained in PBS only; curve “b” was obtained with 1 mM glucose added to the PBS; and the inset is the calibration of the sample obtained at 0.7 V; and

FIG. 9 shows three CVs of a GdmCl-treated sample obtained under three different conditions in the negative polarity of the potential.

### DETAILED DESCRIPTION OF THE INVENTION

Any particular theory that is used in the description, as an attempt to academically understand the mechanism of the invention, should not be interpreted as limitative to the scope of the invention.

The invention provides an electrode with a spatial confining structure that is used to secure an active compound. By spatially confining the active compound in such structure, the activity of the compound is retained, reserved, stabilized, or deactivated to a less extent. As such, the active compound shows a high degree of resistance against deactivation caused by various conditions. For example, the enzyme/protein shows a high degree of resistance against denaturation caused by various conditions.

In specific embodiments, the invention provides an enzyme/protein immobilization technique that can be applied to an active compound such as GOx immobilized on an unmodified electrode, such as a semiconductor electrode, and render enhanced stability for the immobilized enzyme against destabilizing conditions.

Typically, the spatial confining structure permits the active compound to be accessible from outside the spatial confining structure (semi-open), so that the active compound can function as it is intended. For example, it is desirable that an enzyme can contact its substrate and catalyze the reaction involving the substrate.

In various embodiments, the spatial confining structure can be formed on the surface of the electrode with any suitable 3-dimensional shape, such as a corrugation or an irregularity on an otherwise smooth and flat surface. Examples of such a structure include, but are not limited to, groove, straight groove, circular groove, parallel grooves, ditch, alcove, pore, wrinkle, hollow space, void, crack, opening, nook, fissure, cleft, niche, recess, hole, cavity, channel, furrow, rut, excavation, crater, burrow, and the like and any combination thereof.

In various embodiments, the spatial confining structure can have a size or volume that can accommodate one, two or more molecules of the active compound.

The spatially confined structures can be artificially created by any approach. Any suitable mechanical, chemical, and electrical procedure may be used to generate the spatial confining structure. For example, it can be formed by micro/nanofabrication techniques such as optical/UV lithography, chemical etching, and electron beam lithography. In an embodiment, the spatial confining structure comprises a groove formed by scratching the surface of the electrode with a needle. Specifically, the invention comprises creating grooves, or semi-open structures, on an unmodified electrode, such as semiconductor electrode e.g. a silicon wafer, and assembling an enzyme into these semi-open spatially confined structures.

Although in many embodiments, the active compound comprises a catalyst; and the activity of the compound comprises catalytic activity, the active compound may also comprise a wide range of biological or organic entities, such as enzymes, DNA, proteins, and polymers, among others.

In that instance where the active compound can comprises a catalyst, it may comprise a redox catalyst such as one that catalyzes a redox reactant selected from e.g. a group consisting of methanol, ethanol, glucose, hydrocarbons, alkane, methane, ketone, 3β-hydroxybutyrate (3β-OHB), phenol, dopamine, lactose, fructose, and mixtures thereof. The term “redox reaction” is defined as a reduction/oxidation reaction in which atoms have their oxidation number (oxidation state) changed. Oxidation indicates an increase in oxidation number, and reduction indicates a decrease in oxidation number. The term “redox reactant” is defined to include (1) oxidizing agents, oxidants or oxidizers that are oxidative and have the ability to oxidize other substances; and (2) reducing agents, reductants or reducers that are reductive and have the ability to reduce other substances. In many embodiments of the invention, the redox reaction involves the transfer of one or more electrons between an oxidizing agent and a reducing agent.

Examples of redox reactants include, but are not limited to, organic compounds, for example, methanol, ethanol, glucose, hydrocarbons such as methane, the blood ketone 3β-hydroxybutyrate (3β-OHB), phenol, dopamine, lactose, and fructose, etc. and inorganic compounds, for example, sodium nitrite, in solution form and in gaseous form, that can be oxidized using the catalytic composition.

In exemplary embodiments, the redox reactant comprises an organic fuel or a mixture of organic fuels. Examples of organic fuels include, but are not limited to, methanol, ethanol and glucose.

In an exemplary embodiment, the redox catalyst comprises an oxidoreductase such as glucose oxidase (GOx). However, many other oxidoreductases may also be used in the invention, for example, oxidoreductases that act on the following substrates: CH—OH group of donors (alcohol oxidoreductases), the aldehyde or oxo group of donors, the CH—CH group of donors (CH—CH oxidoreductases), the CH—NH₂ group of donors (Amino acid oxidoreductases, Monoamine oxidase), CH-NH group of donors, NADH or NADPH, other nitrogenous compounds as donors, a sulfur group of donors, a heme group of donors, diphenols and related substances as donors, peroxide as an acceptor (peroxidases), hydrogen as donors, single donors with incorporation of molecular oxygen (oxygenases), paired donors with incorporation of molecular oxygen, superoxide radicals as acceptors, metal ions, CH or CH₂ groups, iron-sulfur proteins as donors, reduced flavodoxin as a donor, phosphorus or arsenic in donors, X—H and Y—H to form an X—Y bond, and the like.

The material of the electrode may comprises a polymeric material or a generic solid state material, such as an electrically conductive material selected from metals, semiconductors, superconductors, oxides, and polymers that are used for electrical/electrochemical applications.

In various embodiments, the electrode may be an anode, with which a redox reactant is oxidized; or a cathode, with which a redox reactant is reduced. For example, when the electrode is used as the anode of a fuel cell, it will bring about the oxidation of redox reactants such as methanol, ethanol and glucose, and enables the fuel cell to convert chemical energy to electrical energy. Examples of suitable electrodes include, but are not limited to, silicon electrodes, graphite electrodes, and carbon paper electrodes.

The silicon electrodes can be made of or from n-type or p-type silicon wafers with suitable resistivity ρ. In exemplary embodiments, the silicon electrodes were n-type silicon wafers with resistivity ρ<0.005 Ω-cm.

### Example 1

### Electrode Treatment and Electrochemical Measurements

GOx (EC 1.1.3.4, 15.5 units/mg, from Aspergillus niger) and β-D-(+)-glucose were purchased from Sigma-Aldrich and used as received. All other chemicals were of analytical grade and used without further purification. GOx was dissolved in 0.01 M PBS at pH 7 to reach a concentration of 10 mg/mL. Glucose solutions were prepared overnight before use to allow equilibration of anomers. All solutions were prepared with water (18.2MΩ cm) from a Direct-Q 5 Millipore system.

Heavily doped (ρ<0.005 Ω cm) n-type silicon wafers with (111) orientation were used in this example. The grooves were made by one scratching action on the surface of a silicon wafer using a sewing needle, as described in Yau, S.-T.; That, I.; Strauss, E.; Rana, N.; Wang, G. J. Nanosci. Nanotechnol. 2006, 6, 796. The needle was held with a pair of pliers that was held manually by hand. A moderate pressure was applied to the needle while the surface of a 1 cm×1 cm silicon wafer was scratched. The size of the scratched region was about 3 mm×0.5 mm. The scratched wafer was cleaned in acetone, 2-propanol, and deionized water. Adhesive tape was used to mask the wafer to form a 2 mm×2 mm square about the scratched region. To deposit GOx on both nonscratched and scratched silicon, a drop of the GOx solution was placed on the masked surface, and the sample was sealed in a container for incubation. A wet cotton swab was used to wipe the unscratched region within the square to remove the GOx. The GOx-groove electrode was finally rinsed with PBS and transferred with the sample covered in PBS to an electrochemical cell for measurement. Chemical treatment of the samples was carried out by incubating them in 4 M guanidinium chloride (GdmCl) for 4 hours. Heat treatment was carried out by immersing the samples in water at 80° C. for 60 minutes. The treated electrodes were rinsed with PBS.

The electrochemical measurement system consisted of a conventional three-electrode cell and a potentiostat (Princeton Applied Research, model 283). An electrode including a GOx-groove was used as the working electrode with an active area of 0.04 cm². A commercial (Microelectrode, Inc.) Ag/AgCl (3 M KCl, saturated with AgCl) electrode was used as the reference electrode. A platinum wire was used as the counter electrode. All the experiments were carried out at room temperature (22±1° C.) in 0.01 M PBS as the supporting electrolyte. Deoxygenated PBS was obtained by purging the PBS using highly pure nitrogen for 15 minutes and maintained under a nitrogen atmosphere during the measurements. Atomic force microscopy (AFM) of the samples was performed using the tapping mode.

### Example 2

### Effect of Wafer “Grooving”

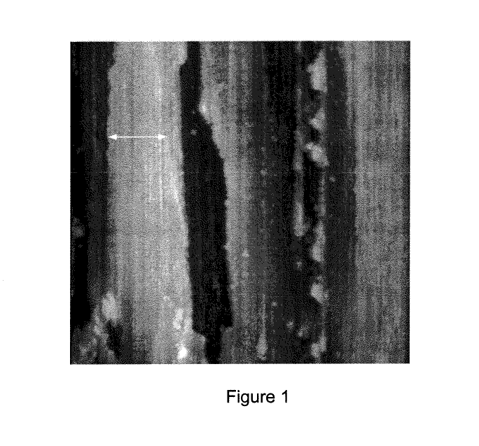

Semi-open spatially confined structures were created by scratching the surface of a heavily doped n-type silicon wafer that contained its native oxide. Scratching the surface of the silicon wafer resulted in parallel grooves with different widths and depths on the nanometer scale. FIG. 1 is an AFM image of the scratched silicon wafer surface, showing parallel grooves and scattered “debris” just outside some grooves due to the scratching. FIG. 1 shows an AFM image (3 μm×3 μm) of the scratched silicon wafer. The span of the gray scale is 400 nm.

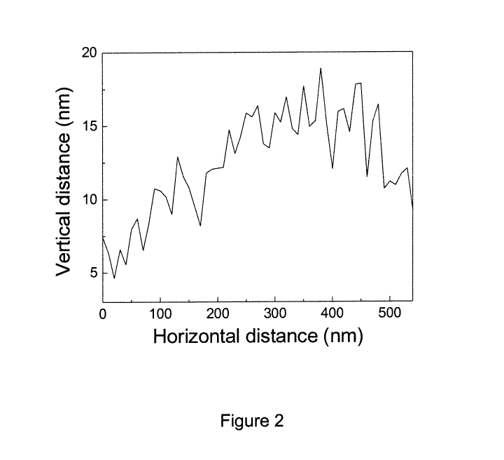

A line profile of a region on the surface as indicated by the white line (arrow) in FIG. 1 is shown in FIG. 2. The line profile shows that the grooves have a typical cross-sectional size of 25 nm×6 nm (width×depth). The actual size of the grooves was smaller than the measured size due to the finite size of the AFM tip. Given that the dimension of the GOx molecule is 60 Å×52 Å×77 Å, it is estimated that about two or three GOx molecules can be accommodated per cross-section of the groove.

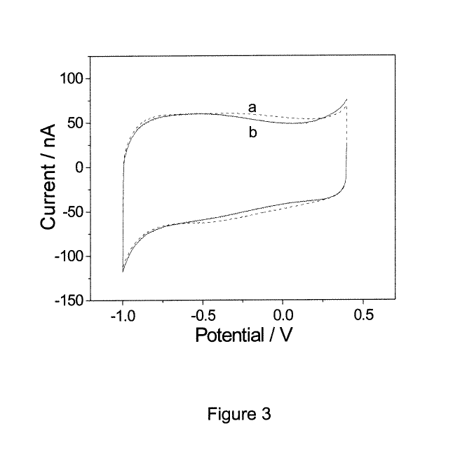

FIG. 3 shows the cyclic voltammograms (CVs) of the scratched silicon wafer of FIG. 1 (curve a) and the flat silicon wafer (curve b) in PBS at pH 7.0. Since the scratched silicon was cleaned using deionized water and left under ambient conditions for about 30 minutes before being used in the voltammetric measurement, an oxide layer was expected to have formed in the scratched region. FIG. 3 shows that the two CVs are almost identical.

### Example 3

### Partial Confinement of GOx

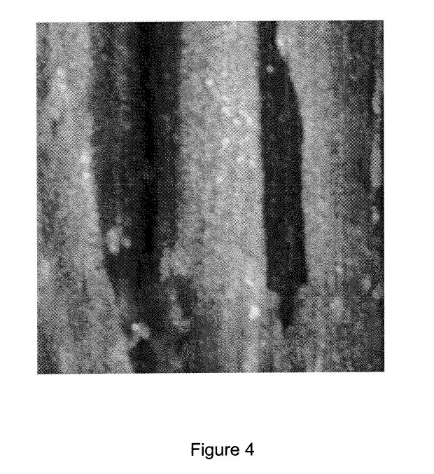

When immobilized on the native oxide of silicon, GOx is known to exhibit its proper redox characteristics with preserved enzymatic activity. FIG. 4 shows the AFM image (2 μm×2 μm) of the same region as in FIG. 1. The span of the gray scale is 400 nm. The AFM image of FIG. 4 shows that the same region as shown in FIG. 1 is covered with a near monolayer of spherical structures. The smallest structure has a diameter of about 21 nm. It is known that, in AFM imaging, the tip-induced convolution effect usually makes nanometer-sized objects appear to be up to several times larger. The 21 nm spherical structures were assigned as a GOx molecule. Within the near monolayer, there are also larger elongated structures of about 30 nm×50 nm, which are likely due to the aggregation of two to three GOx molecules. An inspection of FIGS. 1 and 4 indicates that all of the surface features other than those indicative of the grooves appearing in FIG. 1 are visible in FIG. 4. Thus, it is believed that the GOx molecules that were immobilized in the grooved area were partly confined by the grooves.

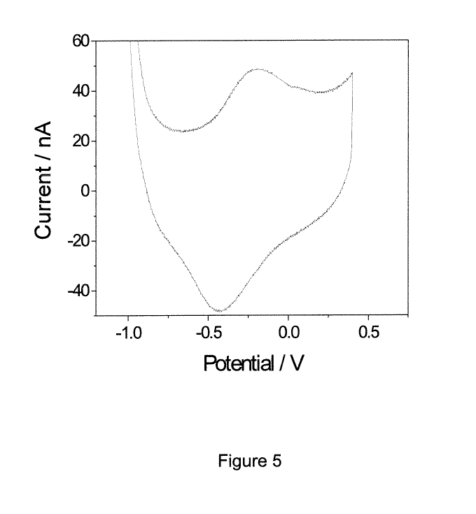

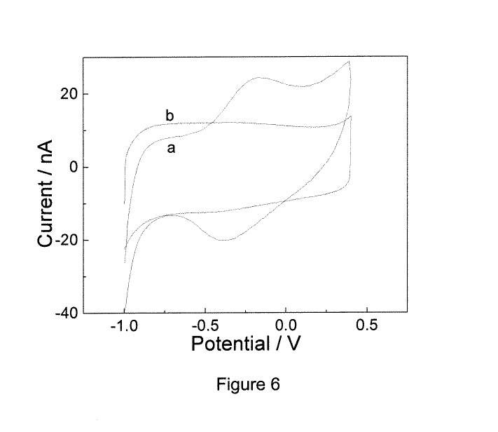

The CV of this GOx-groove sample is shown in FIG. 5. FIG. 5 shows the CV of the GOx-groove sample as in FIG. 4 before treatment. The CV shows the redox peaks of the immobilized GOx with a formal potential of −0.32 V vs Ag/AgCl. This sample was then immersed in 4 M GdmCl, a denaturant, for 4 hours. It was known that if GOx is treated with 4-6 M GdmCl for 2 hours, extensive unfolding of the enzyme takes place due to the strong destabilization character of GdmCl. FIG. 6 shows the CV of the GdmCl-treated GOx-groove sample. The presence of the redox peaks on the CV indicates that the treated GOx was able to retain its redox reaction with the silicon. The formal potential of this redox reaction is about −0.31 V. FIG. 6 shows the CV (curve a) of the GOx-groove sample after a 4 hour GdmCl treatment, and the CV (curve b) of a GOx immobilized flat silicon sample. The background signal due to the silicon without GOx as shown in FIG. 3 has been subtracted for all the CVs. FIG. 6 also shows the CV (curve b) of a GOx-immobilized flat silicon that was treated with GdmCl under identical conditions. The CV is featureless, indicating the detrimental effect the treatment produced on the redox process of the immobilized enzyme. AFM imaging showed that there was still a near monolayer of GOx on the flat electrode surface after the treatment. The absence of redox peaks is likely due to denaturation. However, the GOx immobilized on the grooved surface has survived the treatment.

### Example 4

### Effect of Heat

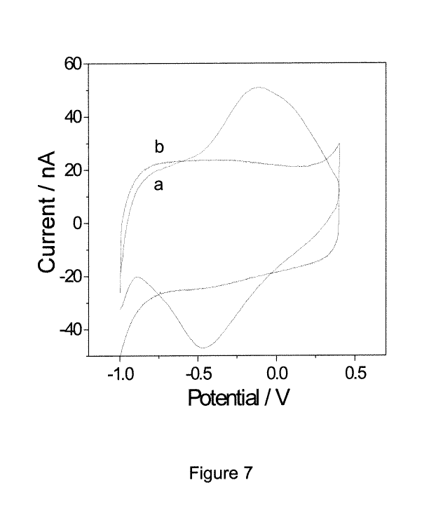

To study the effect of heat, a GOx-groove sample was subjected to high temperature. It is known that an elevated temperature induces instability of enzymes, causing denaturation to occur. It is also known that thermally induced denaturation of GOx occurs at 55.8±1.2° C. with the dissociation of the flavin cofactor. The GOx-groove sample was exposed to 80° C. for 60 minutes. FIG. 7 shows the CV (curve a) of a GOx-groove sample and the CV (curve b) of a GOx-immobilized flat silicon sample. Both samples were exposed to 80° C. for 60 minutes. The background signal due to the silicon without GOx as shown in FIG. 3 has been subtracted for both curves. FIG. 7 shows the CV (curve a) of the heat-treated sample. The redox peaks of GOx are present with a formal potential of −0.31 V. On the contrary, GOx immobilized on flat silicon electrodes show no peaks (curve b) presumably due to the dissociation of the flavin cofactor.

### Example 5

### Redox Properties

The redox properties, i.e., positions of redox peaks (E_{Red} and E_{Ox}) and formal potential (E_{1/2}), of the two kinds of treated GOx-groove samples and of the untreated GOx-groove sample are listed in Table 1.

TABLE 1

| Sample | E_{Red} (V) | E_{Ox} (V) | E_{1/2} (V) |
|---|---|---|---|
| GdmCl | −0.43 | −0.19 | −0.31 |
| High Temperature | −0.48 | −0.14 | −0.31 |
| Untreated | −0.43 | −0.19 | −0.32 |

The presence of the redox peaks on the CV indicates the presence of the redox process between the enzyme and the electrode. The retained redox process of GOx after the destabilizing treatment can be expressed more quantitatively. Since a near monolayer of GOx was present on the electrode, the surface density Γ of active GOx, which gave rise to the redox process, can be estimated using the redox peak current, constants, and experimental parameters. The value of Γ for the GdmCl-treated sample is calculated to be 2.93×10⁻¹² mol/cm², while that for the same sample before treatment is 3.73×10⁻¹² mol/cm². The corresponding values for the high-temperature-treated sample are 3.24×10⁻¹² and 5.18×10⁻¹² mol/cm². In both cases, the value of Γ for the treated sample is very close to that for the untreated sample. Thus, the detrimental effect of the treatment on the redox properties of GOx is insignificant.

### Example 6

### Enzymatic Activity

The retained redox process of GOx, however, does not necessarily imply that the enzyme's activity was preserved. It is known that, even when GOx is unfolded so that it loses its catalytic property for the oxidation of glucose, the denatured enzyme can still produce redox peaks on its CV. The formal potential of an enzyme is usually used as an indication of changes in the conformation and therefore possible denaturation of a protein. Table 1 shows that the formal potentials, E_{1/2}, of the treated GOx are very close to that of the untreated sample. Although this may imply that the conformation of the immobilized GOx remained unchanged after the treatments, the difference between the E_{1/2} values for the present work and that for the native GOx, namely, −0.34 V vs Ag/AgCl, at pH 7, makes a prediction of the preservation of the enzymatic activity of the treated GOx difficult.

To elucidate the enzymatic activity of the treated GOx of the GOx-groove electrode, the electrodes' response to glucose was characterized using two independent electrochemical schemes.

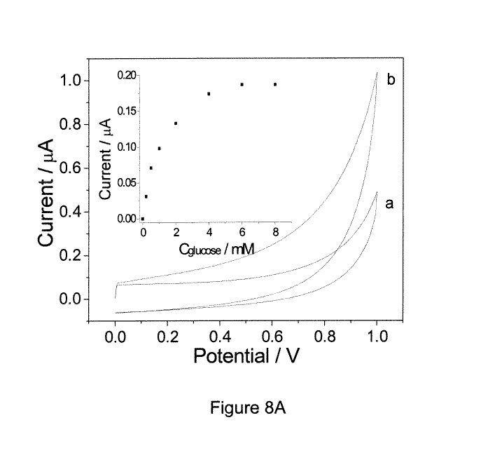

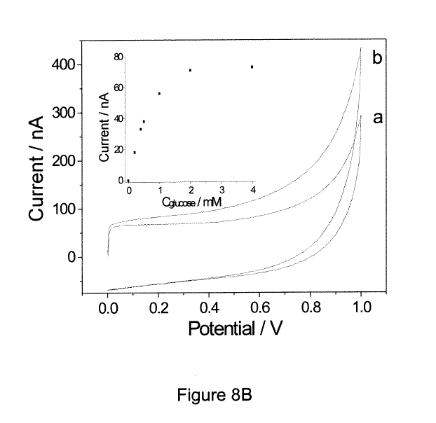

In the first scheme, glucose was introduced to the electrochemical cell that contained a nitrogen-purged phosphate buffer solution (PBS). The potential was then scanned in the positive polarity range. The GOx-induced oxidation of glucose resulted in transporting electrons from glucose via GOx to the silicon. FIG. 8A shows the CV of the GdmCl-treated GOx-groove sample in the positive potential range. Curve a was obtained in PBS only. Curve b was obtained with 4 mM glucose added to the PBS. The inset is the calibration of the sample obtained at 0.7 V. FIG. 8B shows the CV of the GOx-groove sample exposed to 80° C. in the positive potential range. Curve a was obtained in PBS only. Curve b was obtained with 1 mM glucose added to the PBS. The inset is the calibration of the sample obtained at 0.7 V

FIG. 8A shows the CVs obtained with the GdmCl-treated electrode described above. Curve a was obtained without the presence of glucose, while curve b was obtained with 4 mM glucose in the PBS. The inset is the electrode's calibration curve for glucose. The corresponding CVs of the high-temperature-treated electrode are shown in FIG. 8B. The direction in which the current increases with respect to that of the scanning of the potential as shown in the CVs of FIG. 8 indicates that glucose is oxidized so that electrons flow into the electrode. FIG. 8 shows that the treated GOx is still capable of performing the catalytic process (oxidation of glucose). In other words, the enzymatic activity of the treated enzyme is preserved. No such effect was observed using an electrode immobilized with free FAD or denatured GOx.

In the second scheme, the potential was scanned in the negative polarity range of the potential. Working in the negative potential range allows one to observe simultaneously the GOx-silicon electron transfer during the catalytic process. In the experiment, the GOx-immobilized silicon electrode was used as the working electrode in cyclic voltammetry measurements, subjected to the following conditions:

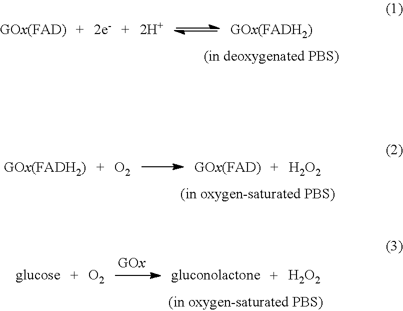

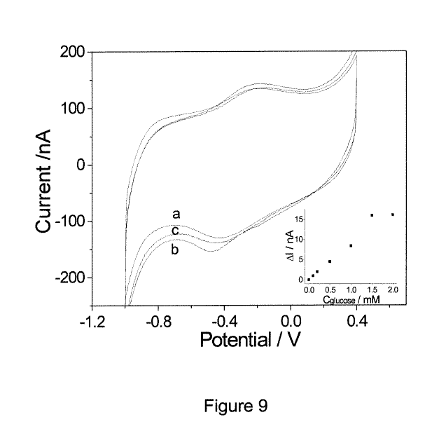

The three reactions are a protocol for detecting glucose by monitoring the change in the reduction current of reaction 1, which is the redox reaction of the immobilized GOx. These conditions correspond to the redox reaction of the immobilized GOx as described by reaction 1, coupled respectively to the oxidation of FADH2 (reaction 2) and to the oxidation of glucose (reaction 3). FIG. 9 shows three CVs of the GdmCl-treated sample obtained under the three conditions. In FIG. 9, CVs of the GdmCl-treated sample are in the negative polarity of the potential. The inset is the calibration curve, where ΔI is the signal current. Curve a in FIG. 9 indicates the presence of the redox reaction of GOx immobilized on the silicon electrode measured in a deoxygenated PBS (reaction 1). When the PBS is saturated with molecular oxygen, the voltammogram changes dramatically with an increase of the reduction peak current and decrease of the oxidation peak current as shown in curve b. The increased reduction peak current indicates that the reduced form of GOx in reaction 1 is oxidized by dissolved O₂ via reaction 2 so that reaction 1 favors more reduction of GOx. Upon adding β-D-(+)-glucose to the O₂-saturated PBS, the reduction peak current decreases as shown in curve c. Being the substrate of GOx, β-D-(+)-glucose gives rise to a GOx-catalyzed reaction, which also consumes dissolved O₂ as indicated by reaction 3. Therefore, because the two competitive reactions (reactions 2 and 3) consume dissolved O₂, reaction 2 and hence the reduction process of reaction 1 are slowed. Thus, the reduction peak current decreases with increasing β-D-(+)-glucose concentration, and the amount of glucose is detected by monitoring the decrease in the reduction peak current of the GOx electrode. The inset shows the electrode's calibration curve for glucose.

### Example 7

### Kinetic Analysis

To study the effect of spatial confinement on the stability of the immobilized GOx, characteristic rate constants for the complete catalytic process of glucose have been calculated using the results of FIGS. 4-8 as listed in Table 2.

TABLE 2

| | Electron-transfer | turnover rate | rate constant of the | |
|---|---|---|---|---|
| | rate constant | constant | biocatalytic process | |
| Sample | kₑₜ (s⁻¹) | kₜₒ (s⁻¹) | k_{red} (M s⁻¹) | Kₘ (mM) |
| GdmCl | 0.35 | 203 | 4.69 × 10³ | 1.28 |
| high temp | 0.028 | 75 | 2.83 × 10³ | 1.08 |
| untreated | 0.46 | 300 | 5.01 × 10³ | 1.13(GdmCl), |
| | | | | 1.47(high temp) |

The electron-transfer rate constant kₑₜ, a redox quantity and calculated using the Laviron method, describes how fast electron transfer takes place at the enzyme-electrode interface. The turnover rate constant kₜₒ is a measure of the number of electrons generated by one GOx molecule per second as a result of the catalytic process, while k_{red} is the rate constant describing the entire substance conversion process. The kₑₜ values of the treated samples are all less than that of the untreated sample, indicating a changed state or conformation of some of the immobilized GOx caused by the treatments. In fact, the slight discrepancy between the formal potentials of the treated samples and that of the untreated sample shown in Table 1 forecasts this change. Nevertheless, the corresponding kₜₒ and the k_{red} for the treated samples are nonzero, and in fact, these rate constants are not drastically different from those for the nontreated sample, indicating preserved enzymatic activity of GOx. Moreover, a comparison between the corresponding kₜₒ and k_{red} of the two treated samples indicates that these rate constants reflect a diminished degree of catalytic process echoing, the same degree of conformational change as indicated by kₑₜ. Thus, although denaturation conditions may have produced some changes in the conformation of the immobilized GOx, spatial confinement has stabilized GOx against complete denaturation so that the enzyme is still able to bring about the catalytic process of glucose.

The general approach to elimination of enzyme/protein denaturation occurring in immobilization is to introduce a layer of organic material between the enzyme/protein and the electrode. A kₑₜ of 1×10⁻⁵ s⁻¹ was obtained for GOx immobilized on a lipid bilayer film modified graphite electrode, and kₑₜ was found to be 0.026 s⁻¹ for GOx immobilized on a gold electrode modified with 3,3′-dithiobissulfocinnimidylpropionate. In the present invention, kₑₜ for the untreated samples was found to be 0.46 s⁻¹, which is significantly larger than those obtained with an intervening layer. The enhanced kₑₜ is a consequence of the enzyme making direct contact with the bare electrode. Table 2 shows that this situation occurs even for the treated samples.

Thermally induced denaturation of GOx was shown to proceed from the native state through an intermediate state to a final denatured homodimer structure, from which the flavin cofactors are dissociated. The second step is an irreversible process of denaturation and has an activation energy of 280 kJ/mol. The fact that not all (about 60%) of the heat-treated GOx has preserved the enzyme's activity suggests that the minimum spatial confinement resulting in effective protection is one that corresponds to an increased enzyme stability of 280 kJ/mol.

An inspection of the calibration curves of FIG. 8 shows that the curves have a fast-rising region at low glucose concentrations C_{g} followed by a saturation region at higher C_{g}, indicating the Michaelis-Menten kinetic process. The apparent Michaelis constant Kₘ provides kinetic information about the catalytic reaction of the glucose-GOx system as measured by cyclic voltammetry. Kₘ is numerically equal to the concentration of the analyte required for the signal current to reach half its maximum value. Therefore, Kₘ indicates how effective a particular catalytic reaction is. Table 2 indicates that the values of Kₘ for the treated samples are not very different from that of the untreated sample. The GdmCl-treated sample has a Kₘ value of 1.28 mM, while that for the same sample before treatment is 1.13 mM. The corresponding Kₘ values for the high-temperature-treated sample are 1.08 and 1.47 mM. Kₘ for the native GOx dissolved in a solution is known to be 33 mM, and immobilization of the enzyme may drastically decrease its Kₘ to single-digit values on the millimolar level. Therefore, the difference in Kₘ between the treated and untreated samples could be a result of experimental error. Since the difference is not significant, the kinetics of the catalytic process seems to be not significantly affected by the treatments.

As such, when GOx is assembled in grooves made on unmodified silicon wafers, the activity of the enzyme is preserved. The activity persists even when the immobilized enzyme is subjected to destabilizing conditions, which generally induce denaturation. These results show that the spatial confinement provided by the grooves enhances the stability of GOx against denaturing conditions, since GOx immobilized on a flat silicon wafer loses its redox ability after denaturing treatments. This phenomenon is further elucidated by examining the estimated values of various physical quantities related to the biocatalytic process of GOx. The technique demonstrated can be used as a general approach for stabilizing enzymes immobilized on an unmodified electrode for e.g. bioelectronic applications.

These examples indicate that the stability of glucose oxidase (GOx) immobilized on a silicon electrode can be enhanced using the spatial confinement. When GOx is assembled in semiopen spatially confined structures created on the unmodified surface of a silicon electrode, the enzyme's activity is preserved under even destabilizing conditions. GOx-immobilized silicon electrodes were treated with guanidinium chloride and high temperature. Cyclic voltammetry measurement of the treated electrodes showed the proper redox characteristics of GOx and indicated the GOx-catalyzed electrooxidation of glucose. When GOx was immobilized on flat silicon electrodes, voltammetric measurement showed null result presumably caused by denaturation of the enzyme. The effect of spatial confinement on enzyme stability is also revealed by analyzing the characteristic rate constants and the kinetic parameter for the complete catalytic process of glucose.

Electrochemical characterization indicates the presence of the enzymatic activity of GOx immobilized on both silicon surfaces containing grooves and the bare silicon surface. The two kinds of enzyme-immobilized electrodes were treated with a denaturing agent and high temperature. It was found that only the spatially confined enzyme preserved its enzymatic activity after the treatments. Different quantities of the catalytic process of glucose were analyzed using the preserved enzymatic activity of the spatially confined GOx. These quantities including characteristic rate constants and the Michaelis constant provide additional information about the effect of spatial confinement on enzyme stability.

The invention also provides an electrochemical device including an electrode comprising a spatial confining structure and an active compound, as described above.

Examples of such an electrochemical device include, but are not limited to, an energy-generation device such as a fuel cell, a memory, an electrochemical reactor, a supercapacitor, a biosensor and a medical device including such a biosensor, and a sensor such as a sensor for detection of a redox reactant. In an embodiment, the invention may be used to make a medical device such as an implantable glucose biosensor, which is the essential part of an artificial pancreas.

As an electrochemical device according to the invention, the fuel cell can be a two-compartment fuel cell, or a one-compartment membrane-less fuel cell. For example, the two-compartment fuel cell may be a direct alcohol fuel cell, in which the anode, on which an enzyme is contained in a spatial-confining structure as described above, catalyzes the electro-oxidation of ethanol. The cathode compartment may contain a buffer solution, which contains either ambient oxygen or was saturated with oxygen. A cathode catalyst such as an enzyme contained in a spatial-confining structure as described above or platinum (Pt) can catalyze the reduction of oxygen dissolved in the solution. Current flows from anode via an external wire to the cathode, delivering power to a load.

For another example, in a single-compartment (membrane-less) hybrid fuel cell has been tested, glucose can be dissolved in a solution as the fuel. Glucose oxidase (GOx), optionally together with microperoxidase (MP-11), can be immobilized on the cathode. GOx catalyzes the oxidation of glucose to produce H₂O₂, which diffuses to MP-11 to be reduced to water using the proton from the anode. Both enzymes are contained in spatial-confining structures.

The electrode of the invention can also be used as sensors for redox reactants such as methanol, ethanol, and glucose in environmental, biomedical and food/beverage applications.

The exemplary embodiments have been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. An electrode comprising a spatial confining structure and an active compound, wherein the spatial confining structure spatially confines the active compound, and stabilizes the activity of the compound.

2. The electrode according to claim 1, in which the spatial confining structure enables the active compound to be accessible from outside the spatial confining structure (semi-open).

3. The electrode according to claim 1, in which the spatial confining structure is a corrugation on the surface of the electrode having a shape of groove, straight groove, circular groove, parallel grooves, ditch, alcove, pore, wrinkle, hollow space, void, crack, opening, nook, fissure, cleft, niche, recess, hole, cavity, channel, furrow, rut, excavation, crater, burrow, and any combination thereof.

4. The electrode according to claim 1, in which the spatial confining structure is formed by micro/nanofabrication techniques such as optical/UV lithography and electron beam lithography.

5. The electrode according to claim 1, in which the spatial confining structure comprises a groove formed by scratching the surface of the electrode with a needle.

6. The electrode according to claim 1, in which the active compound comprises a catalyst.

7. The electrode according to claim 1, in which the active compound comprises a biological or organic entity selected from the group consisting of enzymes, DNA, proteins, and polymers.

8. The electrode according to claim 1, in which the active compound comprises a redox catalyst that catalyzes a redox reactant selected from the group consisting of methanol, ethanol, glucose, hydrocarbons, alkane, methane, ketone, 3β-hydroxybutyrate (3β-OHB), phenol, dopamine, lactose, fructose, and mixture thereof.

9. The electrode according to claim 7, in which the redox catalyst comprises an oxidoreductase such as glucose oxidase.

10. The electrode according to claim 1, in which the electrode comprises a polymeric material or a generic solid state material such as electrically conductive material selected from metals, semiconductors, superconductors, oxides, and polymers that are used for electrical/electrochemical applications.

11. The electrode according to claim 1, in which the electrode is selected from the group consisting of a silicon electrode, a graphite electrode, and a carbon paper electrode.

12. An electrochemical device including an electrode comprising a spatial confining structure and an active compound, wherein the spatial confining structure spatially confines the active compound, and stabilizes the activity of the compound.

13. The electrochemical device according to claim 12, which is selected from an energy-generation device such as a fuel cell, a memory, an electrochemical reactor, a supercapacitor, a biosensor and a medical device thereof, and a sensor such as a sensor for detection of a redox reactant.

14. The electrochemical device according to claim 13, in which the fuel cell is a two-compartment fuel cell.

15. The electrochemical device according to claim 13, in which the fuel cell is a one-compartment membrane-less fuel cell.

16. A method of stabilizing the activity of an active compound, which comprises using an electrode comprising a spatial confining structure, wherein the spatial confining structure spatially confines the active compound.

17. The method according to claim 16, in which the spatial confining structure is a corrugation on the surface of the electrode.

18. The method according to claim 16, in which the spatial confining structure is formed by a micro/nanofabrication techniques such as optical/UV lithography and electron beam lithography.

19. The method according to claim 16, in which the spatial confining structure comprises a groove formed by scratching the surface of the electrode with a needle.

20. The method according to claim 16, in which the active compound comprises a biological or organic entity such as enzymes, DNAs, proteins, and polymers.

21. The method according to claim 16, in which the active compound comprises a redox catalyst that catalyzes a redox reactant selected from the group consisting of methanol, ethanol, glucose, hydrocarbons, alkane, methane, ketone, 3β-hydroxybutyrate (3β-OHB), phenol, dopamine, lactose, fructose, and mixture thereof.

22. The method according to claim 16, in which the active compound comprises glucose oxidase.
